(19) United States
(12) Patent Application Publication
(10) Pub. No.: US 2015/0349612 A1
(43) Pub. Date: Dec. 3, 2015

(54) ROTATING ELECTRICAL MACHINE

(71) Applicant: Murata Manufacturing Co., Ltd., Nagaokayo-shi (JP)

(72) Inventors: Yoshihiro ITO, Nagaokakyo-shi (JP); Shigeo ITO, Nagaokakyo-shi (JP)

(21) Appl. No.: 14/822,943

(22) Filed: Aug. 11, 2015

Related U.S. Application Data
(63) Continuation of application No. PCT/JP2013/083693, filed on Dec. 17, 2013.

(30) Foreign Application Priority Data
Feb. 12, 2013 (JP) 2013-024407

(51) Int. Cl. H02K 11/00; H02K 5/16

(52) U.S. Cl. CPC H02K 11/0047; H02K 11/001; H02K 11/0094; H02K 5/16; H02K 11/0042; H02K 11/0015

(57) ABSTRACT

A rotating electrical machine includes a rotor, a stator, a housing that receives the rotor and the stator and supports the stator so that the rotor is rotatably held in the stator. A transmission controller receives a physical quantity of the rotating electrical machine detected by a sensor through antennas. The antennas are located outside of the housing.

### BACKGROUND OF THE INVENTION

1. Field of the Invention

The present invention relates to a rotating electrical machine, and more particularly, to a rotating electrical machine that is provided with a sensor that detects a physical quantity in the rotating electrical machine.

2. Description of the Related Art

Various rotating electrical machines have been conventionally proposed. For example, JP 2008-109806 A discloses a rotating electrical machine such as shown in FIG. 7. A rotating electrical machine (motor) 101 is a drive unit equipped with a rotor 102 and a stator 103, which is incorporated into a variety of power utilization systems (e.g., a car). The rotating electrical machine 101 is also provided with a housing 105 accordingly so that it can be handled as a structure (unit). The housing 105 receives the rotor 102 and the stator 103 and supports the stator 103 so that the rotor 102 is rotatably held in the stator 103.

When the rotating electrical machine 101 is driven, copper losses and iron losses occur in coils and cores of the rotor 102 and the stator 103, resulting in heat generation. Such heat generation may burn out a coil wire. In particular, for a PM motor using a permanent magnet as the rotor 102, the heat generation causes a serious failure in which a temperature of the rotor 102 exceeds the Curie point of the permanent magnet and, for example, the permanent magnet loses magnetism. Therefore, the temperature of the rotor 102 needs to be monitored.

As such, JP 2008-109806 A proposes installing a temperature monitoring mechanism in the rotating electrical machine 101, which includes an IC tag 106 with a temperature sensor for detecting and storing a temperature of the rotor 102 and an IC tag reader 107 for reading information stored in the IC tag 106 with the temperature sensor by wireless transmission. Each of the IC tag 106 and the IC tag reader 107 is provided with an antenna (not shown) so as to perform wireless transmission. Antennas wound in a coil shape that are magnetically coupled to each other are typically used for such antennas.

In the configuration according to all embodiments of JP 2008-109806 A, both of the IC tag 106 and the IC tag reader 107 are installed in the housing 105 of the rotating electrical machine 101. The antennas which the IC tag 106 and the IC tag reader 107 are provided with are likewise installed.

An alternating current flows through the coils to drive the rotating electrical machine 101 within the housing 5 of the rotating electrical machine 1, generating an alternating magnetic field continuously. When a wound antenna is located in the alternating magnetic field, an induced current is generated and an induced voltage is generated at an antenna end. This phenomenon would occur if an operating frequency of the rotating electrical machine is different from an operating frequency of the temperature sensor and a transmission frequency. If the induced current and induced voltage generated exceed the respective withstand current and withstand voltage of components of IC tag 106 and IC tag reader 107 circuits, the IC tag 106 and the IC tag reader 107 may be damaged. A protection circuit for preventing damage would increase cost of a temperature detecting mechanism.

### SUMMARY OF THE INVENTION

Preferred embodiments of the present invention provide a rotating electrical machine that prevents or reduces, using a simple structure, induced current and induced voltage generated in a wound antenna by an alternating magnetic field generated within a housing when the rotating electrical machine is driven.

A rotating electrical machine according to a preferred embodiment of the present invention includes a rotor, a stator, a housing that contains the rotor and the stator and supports the stator so that the rotor is rotatably held in the stator, a sensor that detects a physical quantity of the rotating electrical machine, and an antenna that transmits the physical quantity. A transmission controller receives the physical quantity. The antenna is located outside of the housing in the above configuration.

An impact of the alternating magnetic field on the antenna is reduced to a negligible level on the outside of the housing so that the reliability of the sensor and the transmission controller is improved with a simple structure.

The sensor detects the physical quantity of the rotor, which can be used as control information to operate the rotating electrical machine in a stable manner. Examples of the physical quantity include temperature, strain, and acceleration.

In order to perform wireless transmission, the antenna includes a first antenna (transmitting antenna) connected to the sensor and a second antenna (receiving antenna) that is connected to the transmission controller and magnetically coupled to the first antenna.

A specific example of such an antenna is a wound antenna. The wound antenna preferably is arranged concentrically or substantially concentrically relative to a rotation shaft and a centrifugal force is applied uniformly to the first antenna, thus providing a structure with high mechanical reliability. The wound antenna also has an effective shape to reduce an antenna installation space. Furthermore, the wound antenna has a shape that allows a distance between the first antenna that rotates with the rotation shaft and the second antenna that does not rotate with the shaft to be kept constant, thus improving transmission stability.

Since the rotation shaft is a conductor, a non-conductive spacer is disposed between the rotation shaft and at least the first antenna.

The first antenna could be directly mounted on the rotation shaft if all or part of the rotation shaft is defined by a separate piece made of a non-conductive material.

According to various preferred embodiments of the present invention, it is possible to prevent or reduce, using a simple structure, induced current and induced voltage generated in the wound antenna by the alternating magnetic field generated within the housing when the rotating electrical machine is driven.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view illustrating a schematic configuration of a rotating electrical machine according to a preferred embodiment of the present invention.

FIG. 2A is a perspective view of a portion of the rotating electrical machine according to a preferred embodiment of the present invention, illustrating a first preferred embodiment of an antenna arrangement. FIG. 2B is an axial sectional view of the portion thereof.

FIG. 3 is an axial sectional view of a portion of the rotating electrical machine according to a preferred embodiment of the present invention, illustrating a second preferred embodiment of the antenna arrangement.

FIG. 4 is an axial sectional view of a portion of the rotating electrical machine according to a preferred embodiment of the present invention, illustrating a third preferred embodiment of the antenna arrangement.

FIG. 5 is an axial sectional view of a portion of the rotating electrical machine according to a preferred embodiment of the present invention, illustrating a fourth preferred embodiment of the antenna arrangement.

FIG. 6 is an axial sectional view of a portion of the rotating electrical machine according to a preferred embodiment of the present invention, illustrating a modification of the fourth preferred embodiment of the antenna arrangement.

FIG. 7 is a sectional view illustrating a schematic configuration of a conventional rotating electrical machine.

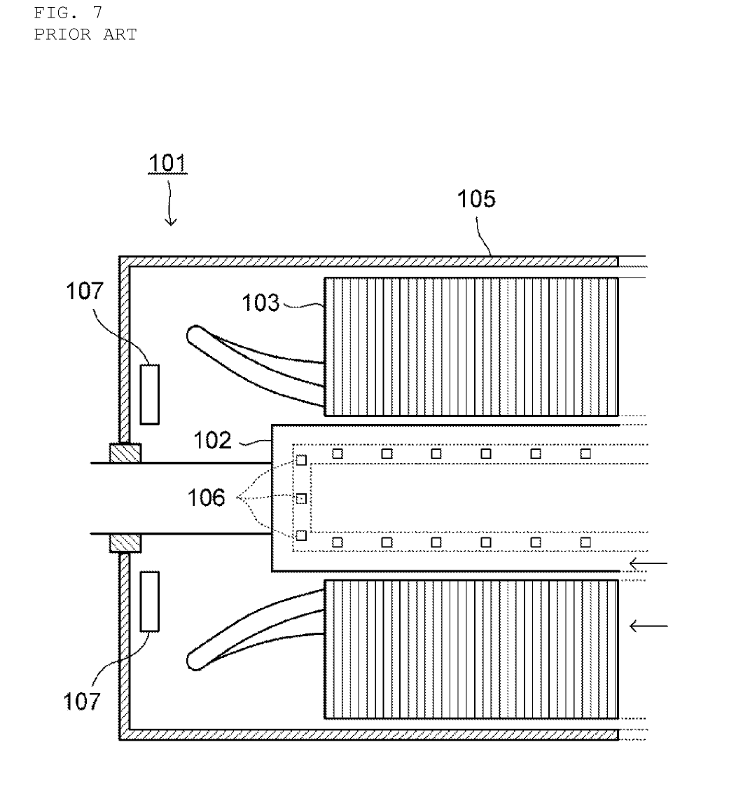

### DETAILED DESCRIPTION OF THE PREFERRED EMBODIMENTS

Preferred embodiments of the present invention are described below with reference to the drawings.

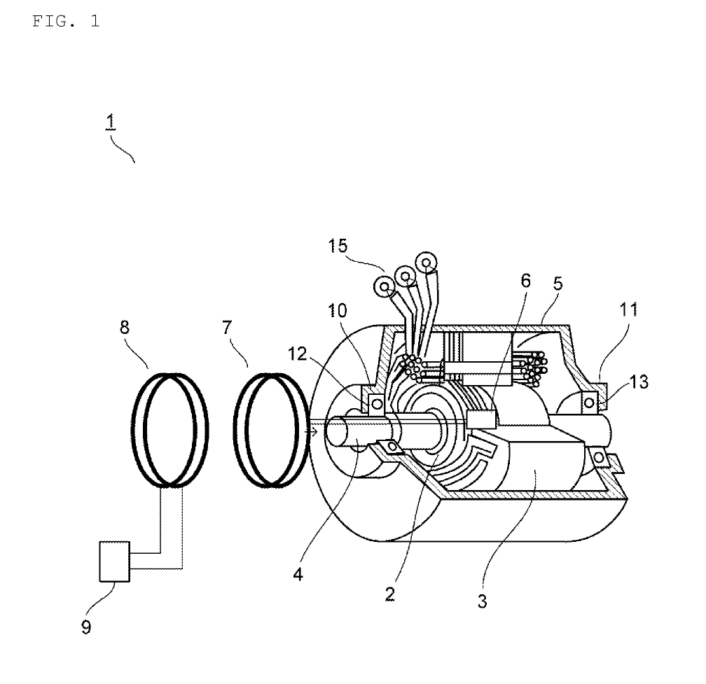

FIG. 1 is a schematic configuration diagram of a rotating electrical machine according to a preferred embodiment of the present invention is applied. As illustrated in FIG. 1, a rotating electrical machine 1 according to a preferred embodiment of the present invention generally includes a rotor 2, a stator 3, a rotation shaft 4, a housing 5, a sensor 6, an antenna (a first antenna 7 and a second antenna 8), and a transmission controller 9. Coils provided in the stator 3 receives an alternating current from an external power supply (not shown) through input lines 16, which rotates the rotor 2, and the rotation shaft 4, i.e., an output shaft, provides power.

The housing 5 receives and contains the rotor 2 and the stator 3. The stator 3 is installed in the housing 5. The rotor 2, which is integrated with the rotary shaft 4, is disposed in the cavity of the stator 3 that is generally donut-shaped. The rotor 2 and the stator 3 are arranged coaxially.

The housing 5 is a cylindrical member including ends. While the housing 5 need not be a conductive material, a metallic material is typically used in view of strength and heat radiation. As illustrated in the figure, both axial ends of the housing 5 hold bearings 12 and 13 and the rotation shaft 4 is supported by the bearings 12 and 13. Thus, the rotation shaft 4 is supported so as to extend axially through the center of the housing 5.

The axial ends of the housing 5 are provided with bearing holders 10 and 11 in a convex manner. The bearing holders 10 and 11 support bearings 12 and 13, respectively. The bearing holders 10 and 11 may be formed integrally with the housing 5 or may be prepared as separate members from the housing and attached to the housing 5 when the rotating electrical machine 1 is assembled.

The sensor 6, which is provided in the housing 5, detects physical quantities of the rotating electrical machine 1. Examples of the physical quantities include temperature and strain of the rotor 2 and acceleration of the rotor 2. If the sensor 6 is a temperature sensing element, a crystal oscillator and other resonant devices (such as a SAW resonator, MEMS resonator, etc.) can be suitably used. An IC tag (RFID) with sensing capability may be used as shown in JP 2008-109806 A.

Physical quantities detected by the sensor 6 are used as control information to maintain stable operation of the rotating electrical machine 1. To this end, the transmission controller 9 is installed outside the housing 5 to receive the physical quantities by transmitting to and from the sensor 6.

The antenna is configured to perform wireless transmission between the sensor 6 and the transmission controller 9. The antenna includes a first antenna 7 (transmitting antenna) connected to the sensor 6 and a second antenna 8 (receiving antenna) connected to the transmission controller 9.

The first antenna 7 and the second antenna 8 are magnetically coupled to each other. A wound antenna is suitably used for such an antenna. The first and second antennas are located outside of the housing 5.

If the wound antennas are used as the antenna and are located inside the housing 5 as described above, an induced current is generated by an alternating magnetic field generated when the rotating electrical machine 1 is driven and an induced voltage is generated at an antenna end. This may cause damage of the sensor 6 and the transmission controller 9. Providing a separate protection circuit would increase the cost.

In order to solve such problems, the first antenna 7 and the second antenna 8 are located outside of the housing 5 according to a preferred embodiment of the present invention. An impact of the alternating magnetic field on the antennas is reduced to a negligible level on the outside of the housing 5 so that the reliability of the sensor 6 and the transmission controller 9 is improved with a simple structure. The sensor 6 and the first antenna 7 are connected, for example, through the rotation shaft 4.

When the antennas 7 and 8 are located outside of the housing 5, flexibility in locating them is very high and it is advantageous that there are fewer limitations in location. However, placing the antenna in a location far away from the housing 5 is undesirable because a space occupied by the rotating electrical machine 1 is increased.

In view of such circumstances, it is clearly contemplated that since the radial dimension of the wound antenna is finite regardless of a winding shape such as circular or rectangular, arranging the wound antenna in such a manner that the rotation shaft 4 extends through the center thereof is most efficient in terms of effective use of space.

Assuming the wound antennas are arranged concentrically or substantially concentrically relative to the rotation shaft 4 near the housing 5, variations of the antenna arrangement are described below.

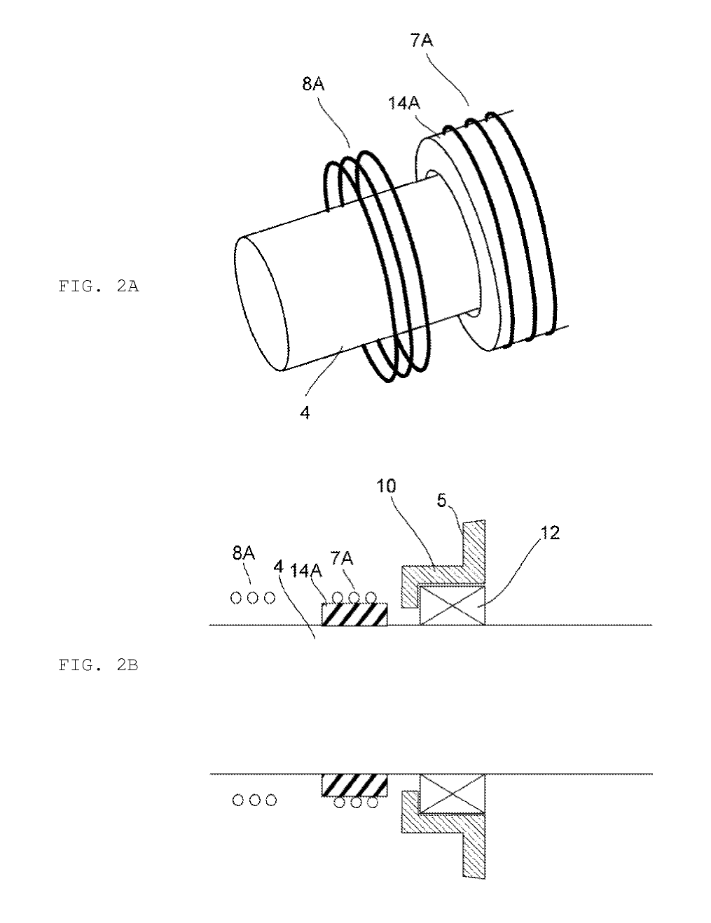

FIGS. 2A and 2B illustrate an antenna arrangement according to a first preferred embodiment of the present invention. Since the rotation shaft 4 is a conductor as described above, mounting in which the antenna comes into contact with the rotation shaft 4 is undesirable due to lack of guarantee on an antenna function. In this example, a spacer 14A made of a non-conductive material is interposed between the rotation shaft 4 and a first antenna 7A. The first antenna 7A is wound in a coil around the spacer 14A.

A second antenna 8A, which is magnetically coupled to the first antenna 7A, is arranged in the vicinity of the first antenna 7A with nothing interposed between itself and the first antenna 7A. In this example, the second antenna 8A is arranged coaxially so as to be magnetically coupled to the first antenna 7A in the axial direction.

While the second antenna 8A depicted in FIGS. 2A and 2B appears not to be supported by any element, the second antenna 8A needs to be really held by any element. In this case, the second antenna 8A may not necessarily be held by the rotating electrical machine 1, while the second antenna 8A is preferably held in a desired position using any other component or circuit board disposed around the rotating electrical machine 1, i.e., without adding a new component, in a system incorporating the rotating electrical machine 1.

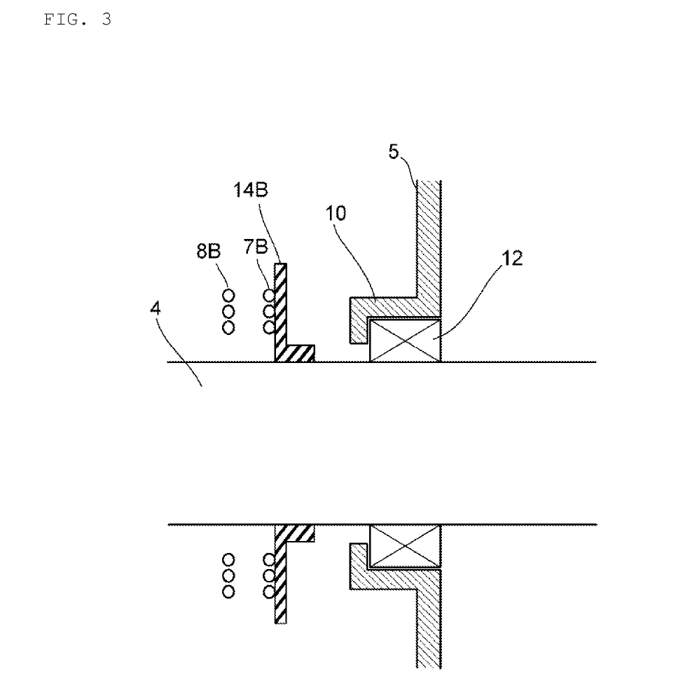

FIG. 3 illustrates an antenna arrangement according to a second preferred embodiment of the present invention. This example is different from the first preferred embodiment in that a first antenna 7B and a second antenna 8B are wound in a planar spiral. The rotation shaft 4 is provided with a flange-shaped holding member 14B made of a non-conductive material, and the first antenna 7B is located on a flange portion of the holding member 14B. The second antenna 8B is fixed in a position where the second antenna 8B is coupled to the first antenna 7B, using any other component or circuit board disposed around the rotating electrical machine 1 in the system incorporating the rotating electrical machine. This example reduces an antenna installation space in the axial direction.

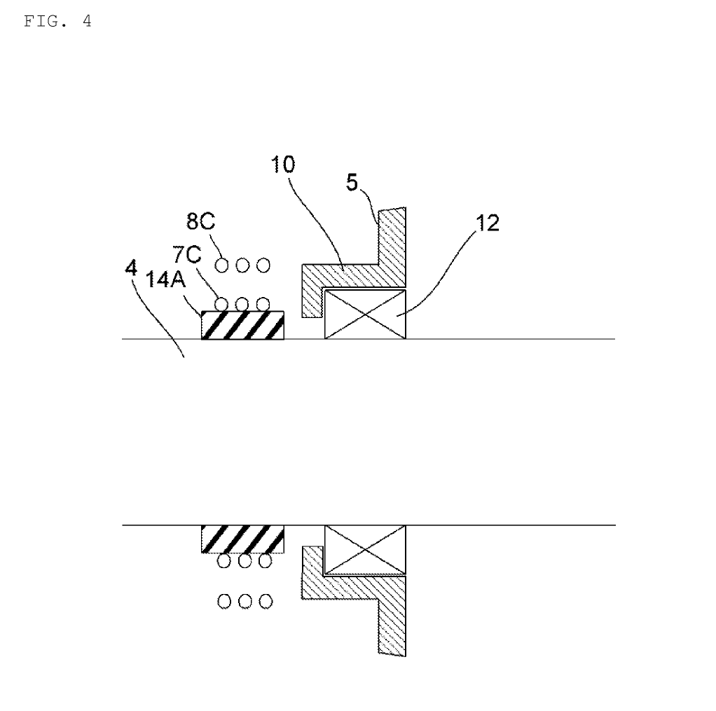

FIG. 4 illustrates an antenna arrangement according to a third preferred embodiment of the present invention. This example is different from the first preferred embodiment in that a second antenna 8C is arranged such that the second antenna 8C surrounds the outside of a first antenna 7C wound in a coil around the spacer 14A. That is, the second antenna 8C is arranged such that the antennas are magnetically coupled to each other in the radial direction. This example further reduces an antenna installation space in the axial direction as compared to the second preferred embodiment and also increases the magnetic field coupling strength.

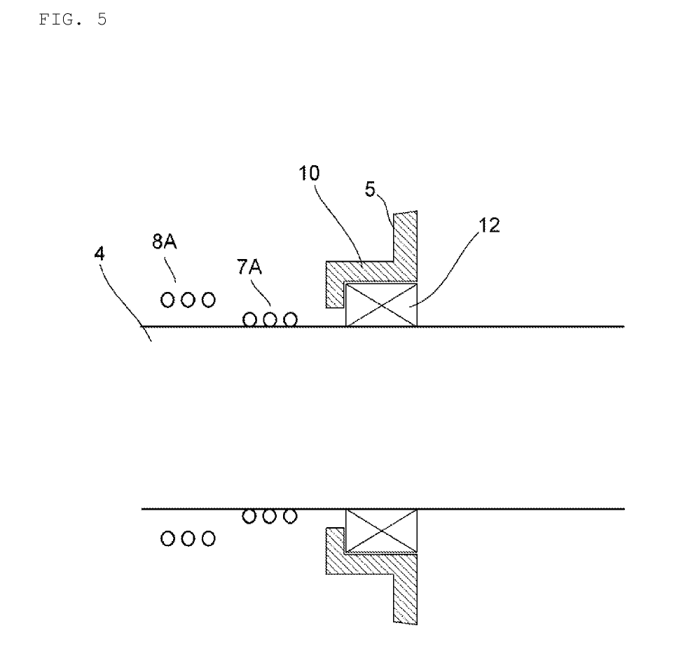

FIG. 5 illustrates an antenna arrangement according to a fourth preferred embodiment of the present invention. In this example, all or part of the rotation shaft 4 preferably is formed using a separate piece made of a non-conductive material. Therefore the first antenna 7A is able to be directly wound around the rotation shaft 4 without interposing a spacer as illustrated in FIG. 5.

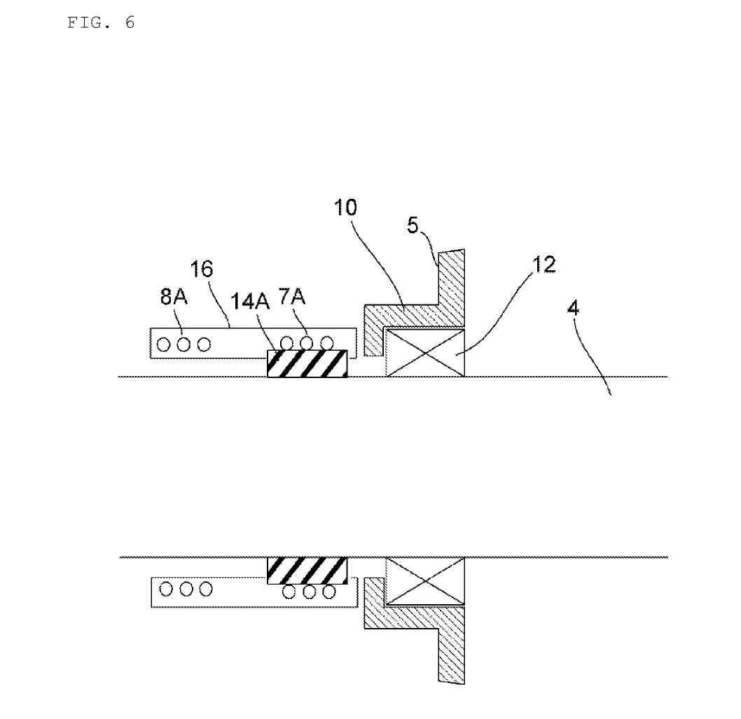

The housing 5 provides substantial shielding against the electromagnetic noise. However, if subjected to an electromagnetic noise other than that, the first antenna 7 and the second antenna 8 are encompassed by a structure 16 made of a metal or a magnetic material such as shown in FIG. 6, thus shielding against unnecessary electromagnetic waves and allowing more stable transmission.

It should be understood that the foregoing descriptions of the preferred embodiments are merely illustrative, and not restrictive, in all respects. The scope of the present invention is defined by the appended claims rather than the foregoing preferred embodiments. Furthermore, the scope of the present invention is intended to cover all modifications within the meaning and the scope equivalent to the claims.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. (canceled)

2. A rotating electrical machine comprising:
a rotor;
a stator;
a housing that contains the rotor and the stator and supports the stator so that the rotor is rotatably held in the stator;
a sensor that detects a physical quantity of the rotating electrical machine;
an antenna that transmits the physical quantity; and
a transmission controller configured to receive the physical quantity; wherein
the antenna is located outside of the housing.

3. The rotating electrical machine according to claim 2, wherein the sensor detects a physical quantity of the rotor.

4. The rotating electrical machine according to claim 2, wherein the antenna comprises a first antenna connected to the sensor and a second antenna that is connected to the transmission controller and magnetically coupled to the first antenna.

5. The rotating electrical machine according to claim 2, wherein the antenna is a wound antenna and is arranged concentrically or substantially concentrically relative to a rotation shaft.

6. The rotating electrical machine according to claim 5, wherein a non-conductive spacer is disposed between the rotation shaft and at least the first antenna.

7. The rotating electrical machine according to claim 5, wherein at least a portion of the rotation shaft is made of a non-conductive material and the first antenna is directly mounted on the rotation shaft.

8. The rotating electrical machine according to claim 2, wherein the physical quantity is a temperature.

9. The rotating electrical machine according to claim 2, wherein the sensor is a resonant device.

10. The rotating electrical machine according to claim 9, wherein the resonant device is a crystal oscillator.

11. The rotating electrical machine according to claim 2, wherein the sensor is an RFID with sensing capability.

12. The rotating electrical machine according to claim 2, wherein the first antenna and the second antenna are disposed inside a structure made of one of a metal and a magnetic material.

13. The rotating electrical machine according to claim 2, wherein bearing holders are provided on axial ends of the housing in a convex manner.

14. The rotating electrical machine according to claim 13, wherein the bearing holders are integral with the housing.

15. The rotating electrical machine according to claim 13, wherein the bearing holders are attached to the housing.

16. The rotating electrical machine according to claim 2, wherein the physical quantity is a strain of the rotor.

17. The rotating electrical machine according to claim 2, wherein the physical quantity is an acceleration of the rotor.

18. The rotating electrical machine according to claim 2, wherein the transmission controller is located outside of the housing to receive the physical quantity by transmitting to and from the sensor.

19. The rotating electrical machine according to claim 2, wherein the antenna is wound in a planar spiral.

20. The rotating electrical machine according to claim 5, wherein the rotation shaft includes a holder member in which the antenna is located.

21. The rotating electrical machine according to claim 4, wherein the second antenna surrounds an outside of the first antenna wound in a coil around a spacer.
